(19) United States
(12) Patent Application Publication
(10) Pub. No.: US 2007/0061781 A1
(43) Pub. Date: Mar. 15, 2007

(54) Stochastic testing directed by static test automation

(75) Inventor: Wayne Bryan, Bellevue, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/225,964

(22) Filed: Sep. 13, 2005

(51) Int. Cl. G06F 9/44

(52) U.S. Cl. 717/124

(57) ABSTRACT

A static automated test is applied to software under test. The commands of the static test are fixed and they operate the software and/or provide inputs to the software, thus driving the software under test into different states. When the software under test is in a particular state, a stochastic test is optionally applied to the software. The stochastic test aimlessly explores the operation of the software under test from the starting point of the particular state.

### BACKGROUND

Software testing checks whether or not software operates as intended. When software does not operate as intended, yielding unexpected results, this is due to defects in the software. The correction of these defects, and the introduction of new features or the enhancement of existing features, may introduce new defects into the software. Repeated testing improves the likelihood of catching defects soon after their introduction.

Manually testing software, by having a person operate the software, provide inputs to the software, and examine the behavior and outputs of the software, may be appropriate in certain situations because it provides immediate benefits. However, in the long run, it is tedious for the person and an inefficient use of the person's time and effort. Consequently, automated tests that are planned in advance and run without human intervention are popular.

There are different types of automated tests, including, for example, static automated tests, state-based stochastic tests, and stateless stochastic tests. Each time a static test is executed, the same sequence of commands are implemented in the same order. Implementing the commands operates the software and provides inputs to the software. Different static tests can be created to provide wide coverage of the software across many configurations. Configurations may vary according to hardware, operating system, international variations, the other programs installed on the machine, and variations of the software under test. The static test likely also includes verifications of expected results. An automated test execution system can run static tests without human intervention, so that repeated testing is performed quickly and efficiently. Static tests can be programmed directly or generated using a test generation tool, of which several are commercially available.

For state-based stochastic tests, also known as “smart monkeys”, the software is described by a model that includes a set of states and a set of actions that result in transitions between the states or remaining in a particular state. The state-based stochastic test randomly selects actions from the set in the model. As those actions are performed, the software is driven to various states in the model. The more accurate and comprehensive the model, the better the tests.

Stateless stochastic tests, also known as “dumb monkeys”, are ignorant of the software and its states and randomly select from all possible actions without regard to which actions are legal or illegal, and without regard to which actions are functionally meaningful. Since the actions tried may not have been considered by a person, such stochastic tests may find defects that are not found by static tests or by state-based stochastic tests. Stateless stochastic tests tend to aimlessly meander through the ‘space’ of possible tests and may not reach some important features or interesting program and user states.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A static automated test is applied to software under test. The commands of the static test are fixed and they operate the software and/or provide inputs to the software, thus driving the software under test into different states. When the software is in a particular state of interest, the static test is suspended and a stochastic test is applied to the software under test. The stochastic test aimlessly explores the operation of the software under test from the starting point of the particular state of interest, by performing random actions on the software under test.

The stochastic test may be provided as part of a test generation tool and/or an automated test execution system. The static automated test may be generated using a test generation tool. The static automated test may be executed using an automated test execution system or may be stand-alone.

### BRIEF DESCRIPTION OF THE DRAWINGS

Embodiments are illustrated by way of example and not limitation in the figures of the accompanying drawings, in which like reference numerals indicate corresponding, analogous or similar elements, and in which:

FIG. 1 is a flowchart illustration of a method for automated testing of software, according to an embodiment of the invention;

FIG. 2 is an illustration of an exemplary static test having two marker calls embedded therein and exemplary “screenshots” of the software under test as commands of the static test are implemented;

FIG. 3 is a flowchart illustration of a method implemented by the code called by the marker call, according to an embodiment of the invention;

FIG. 4 is an illustration of another exemplary static test having a call to a common logging function or procedure and exemplary “screenshots” of the software under test as commands of the static test are implemented;

FIG. 5 is a flowchart illustration of a method implemented by the code that intercepts the call to the function or procedure, according to an embodiment of the invention;

FIG. 6 is a block diagram of a test generation tool and an automated test execution system, according to some embodiments of the invention;

FIG. 7 is a block diagram of a test generation tool and an automated test execution system, according to other embodiments of the invention; and

FIG. 8 illustrates an exemplary system for implementing embodiments of the invention, the system including one or more computing devices.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of embodiments of the invention. However it will be understood by those of ordinary skill in the art that the embodiments may be practiced without these specific details. In other instances, well-known methods, procedures and components have not been described in detail so as not to obscure the embodiments of the invention.

A company's test designers may have created dozens and even thousands of static tests for its software. This set of static tests encompasses valuable knowledge of the software, user scenarios, and expected configurations. Static tests can be designed and directed to test deep into important areas of the software. However, static tests are limited to the commands and verifications they include, and some sequences of commands and inputs are inevitably excluded.

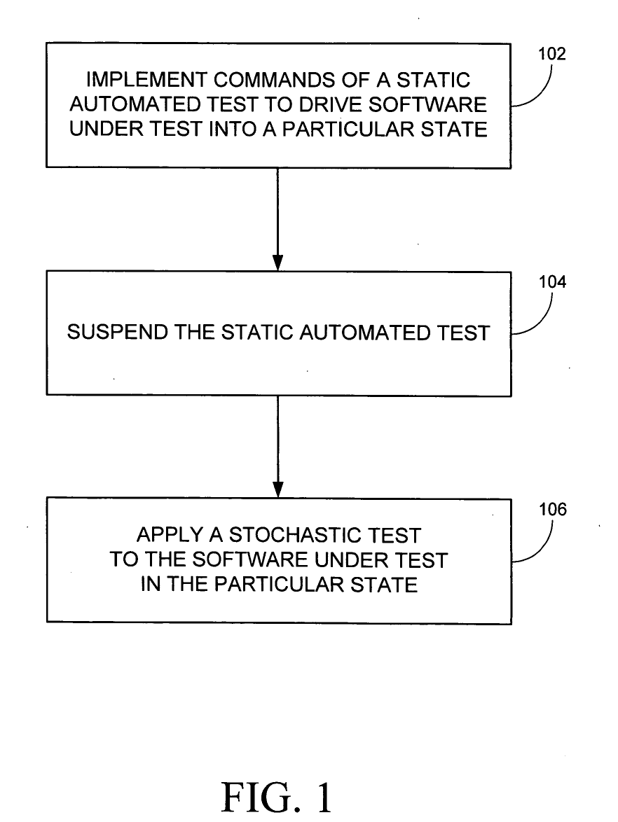

FIG. 1 is a flowchart illustration of a method for automated testing of software, according to an embodiment of the invention. This method for automated testing of software leverages the valuable knowledge embodied by the static tests and the inherent unpredictability of stochastic testing. At 102, a static test is used to drive the software under test into a particular state of interest. At 104, the static test is suspended. At 106, a stochastic test is applied to the software under test while in the particular state of interest. The stochastic test aimlessly explores the operation of the software under test from the starting point of the particular state of interest. The stochastic test may uncover defects in the software under test that were previously unknown.

The stochastic test may be state-based, with the model representing all or a portion of the software under test that includes the particular state of interest. The state-based stochastic test randomly selects from all possible actions defined in the model. Since the state-based stochastic test understands the functional aspects of the software under test, it can detect functional defects in the software under test.

Alternatively, the stochastic test may be a stateless stochastic test. In one embodiment, the stateless stochastic test may be completely ignorant of the software under test, randomly selecting from all possible actions without regard to which actions are legal or illegal, and without regard to which actions are functionally meaningful. A non-exhaustive list of examples of the possible actions includes key presses, mouse clicks, click and drag, movement of the mouse, and the like. In another embodiment, the stateless stochastic test may understand certain aspects of the environment of the software under test. For example, if the stateless stochastic test has some understanding of the graphic user interface (GUI) of the software under test, the stateless stochastic test randomly selects from all possible actions within the limits of the GUI. A non-exhaustive list of examples of the possible actions includes selecting a menu, selecting a menu item, pressing a command button, checking or unchecking a check box, selecting a radio button, providing input to an edit box, and the like. However, even these random actions are selected without regard to which actions are functionally meaningful.

Since the stateless stochastic test is ignorant of the functional aspects of the software under test, it does not detect functional defects in the software under test. For example, if an action is supposed to change the color of selected text from black to green, and instead the action changes the color of the selected text to blue, this defect will likely not be detected by the stateless stochastic test. However, the stateless stochastic test will find serious defects such as crashes and hangs, memory and other resource leaks, and other serious defects common to any software. Finding these serious defects is especially important in today's software industry where they can be exploited by malicious persons.

In one embodiment of the invention, the static test has embedded therein one or more marker calls to code that checks whether to return to the static test or to apply a stochastic test to the software under test. The point in the static test at which a marker call is embedded corresponds to a particular state of the software under test. Implementing the commands of the static test from its start until the point at which the marker call is embedded drives the software under test into that particular state. By embedding more than one marker call in a static test, different states of interest can be targeted as different starting points for stochastic testing.

Depending on the automated test execution system, the marker call may include some identification of the software under test as a parameter so that the code can pass the identification of the software under test to the stochastic test. For example, the marker call may be of the form Marker (ProcessID), where ProcessID is the identifier of the operating system process corresponding to the software under test. Alternatively, the automated test execution system may be such that the stochastic test has access to identification of the software under test without that information being passed to the stochastic test by the marker call from the static test.

If two or more marker calls to the code are embedded in the static test, then the marker calls may include a parameter that distinguishes each marker call from the others and another parameter that indicates the total number of such marker calls in the test. For example, the marker call may be of the form Marker (MarkerID, MarkerTally) or Marker (ProcessID, MarkerID, MarkerTally), where MarkerID is an identification of the marker call in the test (the second marker call could have MarkerID=2), and where MarkerTally is the total number of such marker calls in the test (if there are five marker calls in the test to this code, then MarkerTally=5).

The automated test execution system can use the marker calls to suspend the execution of the static test when the software under test reaches an interesting state and to optionally apply the stochastic test to the software in that state. For example, the automated test execution system may repeatedly execute the static test, where in one repetition no marker calls apply the stochastic test, in another repetition only the first marker call applies the stochastic test, in yet another repetition only the second marker call applies the stochastic test, and so on. In another example, the automated test execution system may randomly pick for each repetition of the static test which one of the marker calls is to apply the stochastic test in that repetition.

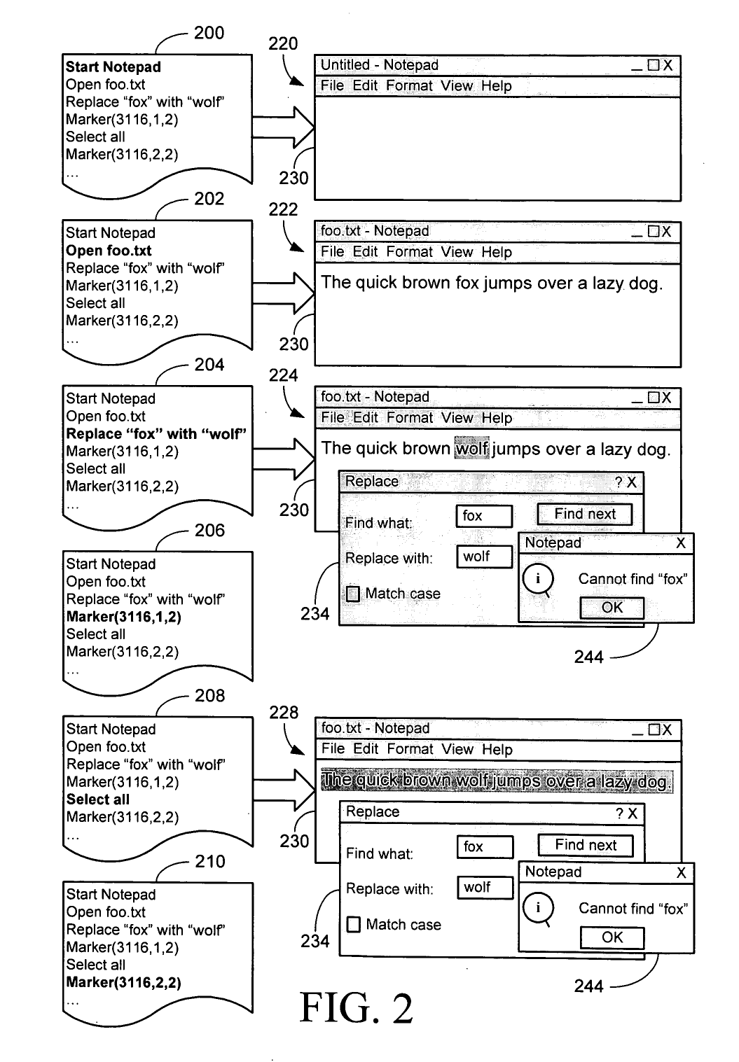

FIG. 2 is an illustration of an exemplary static test having two marker calls embedded therein and exemplary “screenshots” of the software under test as commands of the static test are executed. In this example, the software under test is “MICROSOFT®” Notepad, however embodiments of the invention are equally applicable to any software that is suitable for being tested by automated testing.

Excerpts 200, 202, 204, 206, 208 and 210 show portions of the same static test, and in each excerpt, a different command is emphasized. One or more components of the automated test execution system implement the commands of the static test in sequence by performing the appropriate actions, thus driving the software under test. After each command is implemented, the software under test is in a different state.

For example, the command ‘Start Notepad’ is implemented to start the “MICROSOFT®” Notepad software. Screenshot 220 is an exemplary illustration of a window 230 opened by the software under test.

The next command in the static test, ‘Open foo.txt’, is implemented to open the file entitled “foo.txt”. In this example, the text stored in the file “foo.txt” is “The quick brown fox jumps over a lazy dog.”, and this text is displayed in window 230, as shown in screenshot 222.

The next command in the static test, ‘Replace “fox” with “wolf”’, is implemented to replace the first occurrence of “fox” in the text with “wolf”. In this example, implementation of this command causes the text “The quick brown wolf jumps over a lazy dog.” to be displayed in window 230 with the word “wolf” selected, as shown in screenshot 224. Screenshot 224 also shows dialog boxes 234 and 244 that appear in response to implementing this command.

The next command in the static test, ‘Marker (3116, 1, 2)’, is a marker call. The first parameter, 3116, is the process identifier of the software under test, the second parameter, 1, indicates that this is the first marker call in the static test, and the third parameter, 2, indicates that there are two marker calls in total in the static test. When implemented by the. automated test execution system, this command calls code that checks whether to return to the static test or to apply a stochastic test to the software under test.

In this example, one or more settings of the automated test execution system are set so that for the first marker call, the decision is not to apply the stochastic test. The code called by the marker call therefore returns to the static test. Therefore, the next command in the static test, ‘Select all’, is implemented to select all the text in window 230, as shown in screenshot 228.

The next command in the static test, ‘Marker (3116, 2, 2)’, is a marker call. The second parameter, 2, indicates that this is the second marker call in the static test. When implemented by the automated test execution system, this command calls code that checks whether to return to the static test or to apply a stochastic test to the software under test.

In this example, one or more settings of the automated test execution system are set so that for the second marker call, the decision is to apply a stochastic test to the software under test. The stochastic test would then be started targeted to the software under test, and the static test would be suspended and then exited once it is convenient to do so.

The stochastic test, if a completely ignorant “dumb monkey”, will aimlessly explore the operation of “MICROSOFT®” Notepad from the starting point represented by screenshot 228 by performing randomly selected actions. For example, the stochastic test may left-click the mouse somewhere in dialog box 234, then press the keys <h>, <*>, <Alt>, <k>, then move the mouse, then press <Enter>, then right-click the mouse somewhere in window 230, and so on.

Alternatively, if the stochastic test is a “dumb monkey” that understands that “MICROSOFT®” Notepad has “WINDOWS®”-based GUI, then the stochastic test will aimlessly explore the operation of “MICROSOFT®” Notepad from the starting point represented by screenshot 228 by performing randomly selected actions in the context of that GUI. For example, the stochastic test may select the menu “Help”, then close dialog box 234, then click somewhere in window 230 and enter random keystrokes <7><m><$><3><P><&><a>, then select menu “File”, and so on.

A stateless stochastic test will continue to run until it causes the software under test to crash or hang, or until it is stopped by the automated test execution system, for example, for having reached a time limit or a maximum number of operations. A state-based stochastic test will continue to run until a functional defect in the software under test is found, until it causes the software under test to crash or hang, or until it is stopped by the automated test execution system, for example, for having reached a time limit or a maximum number of state transitions, or for having reached all states in the model, or for having performed all state transitions in the model.

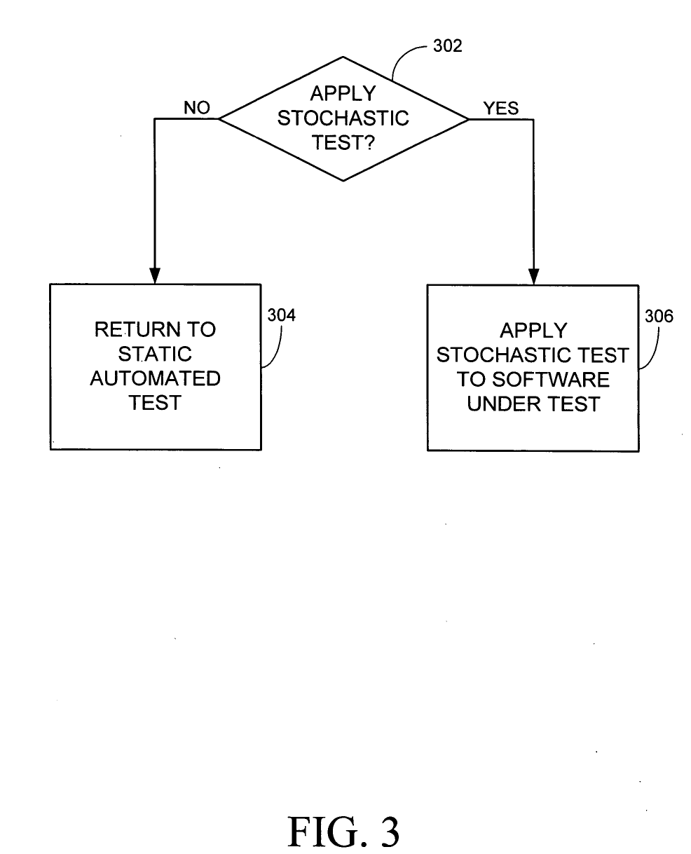

FIG. 3 is a flowchart illustration of a method implemented by the code called by the marker call, according to an embodiment of the invention. At 302, the code checks whether to apply a stochastic test to the software under test. The precise manner in which this decision is made will depend upon the automated test execution system. For example, the code called by the marker call may check by examining the values of one or more programmable global environment parameters, input parameters, or other configuration data of the automated test execution system. If the decision is not to apply the stochastic test, then at 304 the code returns to the static test to continue implementation of the static test from the point at which the marker call to the code was made. Otherwise, at 306, the code initiates the stochastic test in such a way that the stochastic test is applied to the software under test in the particular state the software under test was at the time the marker call was made.

Instead of a marker call to code that checks whether to return to the static test or to apply a stochastic test to the software under test, the static test may have embedded therein code that checks whether to apply a stochastic test to the software under test. The precise manner in which this decision is made will depend upon the automated test execution system. For example, the code embedded in the static test may check by examining the values of one or more programmable global environment parameters, input parameters, or other configuration data of the automated test execution system. If the decision is to apply the test, the code initiates the stochastic test in such a way that the stochastic test is applied to the software under test in the particular state the software under test was at the time the code was executed. Such code may be embedded at one or more locations in the static test.

In another embodiment of the invention, calls to a common function or procedure that is called by two or more static tests are intercepted to enable the optional transfer of test execution from the static tests to a stochastic test. For example, different static tests may call the same logging or verification function. In this embodiment, no changes need to be made to the static tests in order to enable the optional transfer of test execution from the static tests to a stochastic test.

There are many standard software practices for intercepting a call to a function or procedure to allow control to be transferred to a different function or procedure. A non-exhaustive list of examples of such software practices includes using a proxy dynamic linked library (DLL), creating a subclass of an existing function, code overwriting, and altering the Import Address Table. The precise implementation of this embodiment will depend on the design of the calls to the common functions or procedures.

For example, an application program interface (API) wrapper may be used that matches the API signature of the common function or procedure. The API wrapper optionally transfers control to the stochastic test and otherwise calls the actual function or procedure.

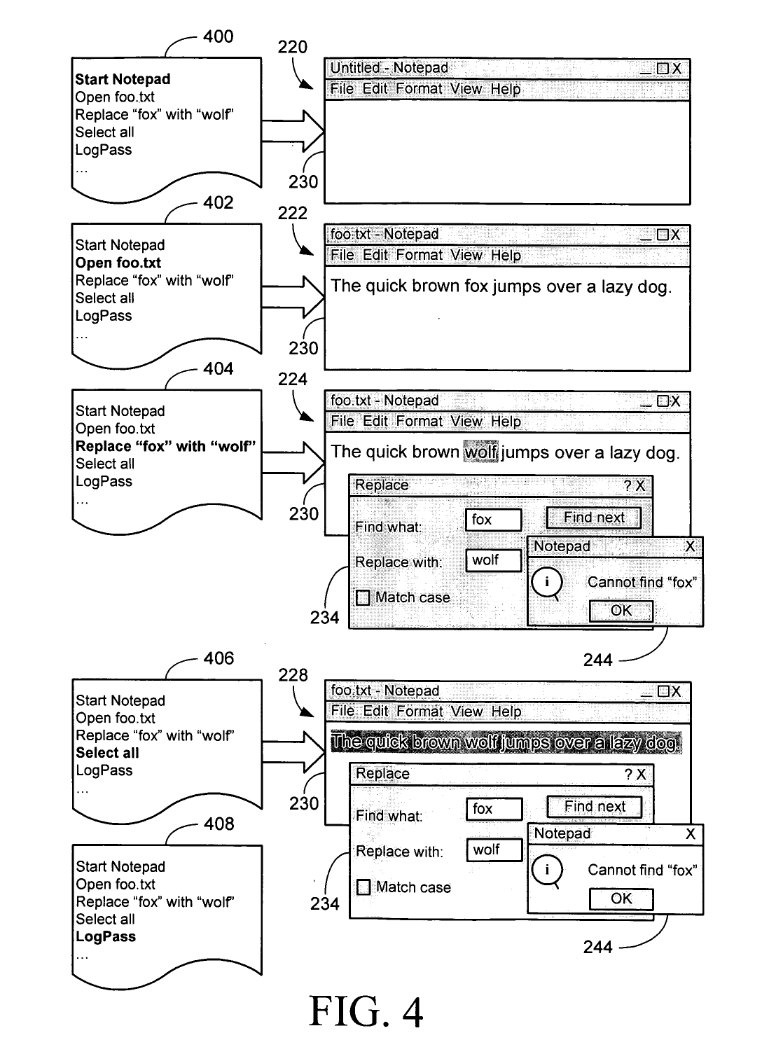

FIG. 4 is an illustration of another exemplary static test having a call to a common logging function and exemplary “screenshots” of the software under test as commands of the static test are executed. In this example, the software under test is “MICROSOFT®” Notepad, however embodiments of the invention are equally applicable to any software that is suitable for being tested by automated testing.

Excerpts 400, 402, 404, 406 and 408 show portions of the same static test, and in each excerpt, a different command is emphasized. One or more components of the automated test execution system implement the commands of the static test in sequence by performing the appropriate actions, thus driving the software under test. After each command is implemented, the software under test is in a different state.

The first four commands in the static test, namely ‘Start Notepad’, ‘Open foo.txt’, ‘Replace “fox” with “wolf”’, and ‘Select all’are implemented by the automated test execution system and yield screenshots 220, 222, 224 and 228, respectively, all of which have been discussed hereinabove with respect to FIG. 2.

The fifth command in the static test, ‘LogPass’, emphasized in excerpt 408, is a call to a function or procedure that records data to a log file. This logging function or procedure is likely called in several different static tests and may even be called more than once in a single static test.

The call to the logging function or procedure is intercepted by an API wrapper of LogPass that checks whether to call the actual logging function or procedure or to apply a stochastic test to the software under test.

In this example, one or more settings of the automated test execution system are set so that the decision is to apply the stochastic test. The stochastic test would then be started targeted to the software under test, and the static test would be suspended and then exited once it is convenient to do so.

In this example, the call to LogPass does not have any parameters, because identification of the software under test was passed to the library in which LogPass appears when the test was initialized.

The stochastic test, if a completely ignorant “dumb monkey”, will aimlessly explore the operation of “MICROSOFT®” Notepad from the starting point represented by screenshot 228 by performing randomly selected actions. For example, the stochastic test may press the keys <?>, <6>, <Ctrl>, then click and drag the mouse somewhere in dialog box 244, then press the keys <M><4><f>, and so on.

Alternatively, if the stochastic test is a “dumb monkey” that understands that “MICROSOFT®” Notepad has “WINDOWS®”-based GUI, then the stochastic test will aimlessly explore the operation of “MICROSOFT®” Notepad from the starting point represented by screenshot 228 by performing randomly selected actions in the context of that GUI. For example, the stochastic test may press the help icon of dialog box 234, then select the menu “View”, then select the menu “Edit”, then click somewhere in window 230 and enter random keystrokes <G><5><c><U><%>, and so on.

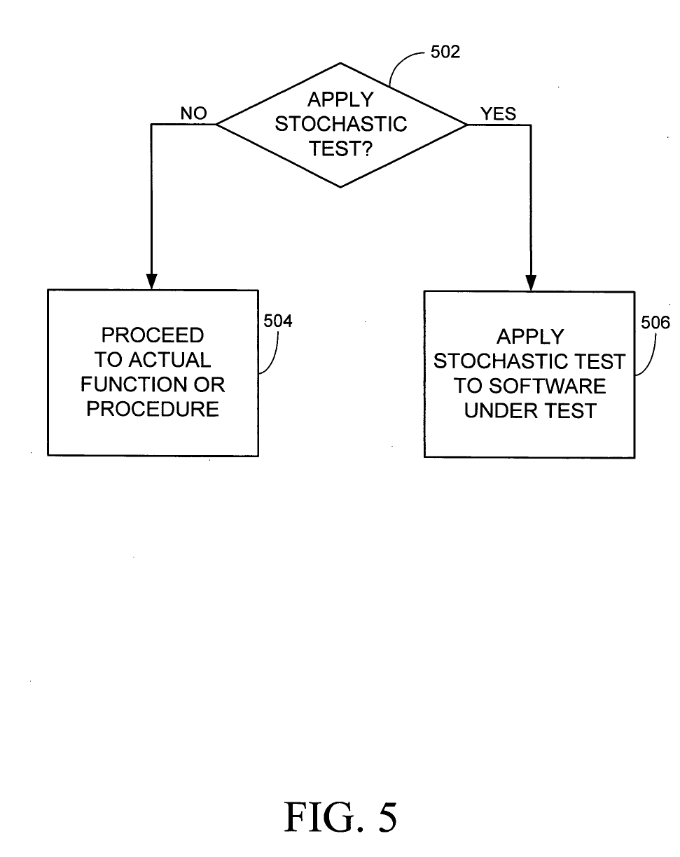

FIG. 5 is a flowchart illustration of a method implemented by the code that intercepts the call to the function or procedure, according to an embodiment of the invention. At 502, the code checks whether to apply a stochastic test to the software under test. The precise manner in which this decision is made will depend upon the automated test execution system. For example, the code may check by examining the values of one or more programmable global environment parameters, input parameters, or other configuration data of the automated test execution system. Appropriate values for these parameters or configuration data control may be chosen in order to control at which intercepted call to the logging function the stochastic test is applied. If the decision is not to apply a stochastic test, then at 504 the code proceeds to the actual function or procedure, and upon its completion, returns to the static test to continue implementation of the static test from the point at which the call to the function or procedure was made. Otherwise, at 506, the code initiates the stochastic test in such a way that the stochastic test is applied to the software under test in the particular state the software under test was at the time the call to the function or procedure was made.

Several test generation tools and automated test execution systems are commercially available. The test generation tool and the automated test execution system may be integrated into a single product, or may be separate products that work in an integrated fashion. Moreover, some of the functionality attributed in this description to the automated test execution system may in fact be functionality of the test generation tool. Automated test execution systems may also work on tests that are not generated using a test generation tool.

For example, some test generation tools record a process by emulating user actions on the software. Some test generation tools also enable the person designing the test to add specific actions, calls to common functions such as verification procedures and logging procedures, and the like. The test generation tool then enables the person designing the test to convert the recorded process into a test. Tests can be scheduled for execution at a certain time, and reports created after the tests have been executed. As the automated test execution system executes the tests, it operates the software automatically, as though a real user were performing each step in the process.

Although the preceding description has referred to tests of software that mimic how a user would use the software, embodiments of the invention are equally applicable to tests of software that do not involve user actions. In one example, merging information from a database into a “MICROSOFT®” Word document could be tested. In another example, software that gets inputs from a network could be driven by a static test into a state of interest and then the stochastic test could provide random commands over the network.

In an embodiment of the invention, a test generation tool is used to generate a test of software. When the test is executed by an automated test execution system, the system implements commands of a static automated test to drive the software into a particular state of interest and optionally applies a stochastic test to the software in the particular state. The stochastic test aimlessly explores the operation of the software under test from the starting point of the particular state of interest.

Some embodiments of the invention may be described in the general context of computer-executable instructions, such as program modules, executed by one or more computers or other devices. Generally, program modules include routines, programs, functions, dynamic linked libraries (DLLs), applets, native instructions, objects, components, data structures, etc. that perform particular tasks or implement particular abstract data types. Typically the functionality of the program modules may be combined or distributed as desired in various embodiments.

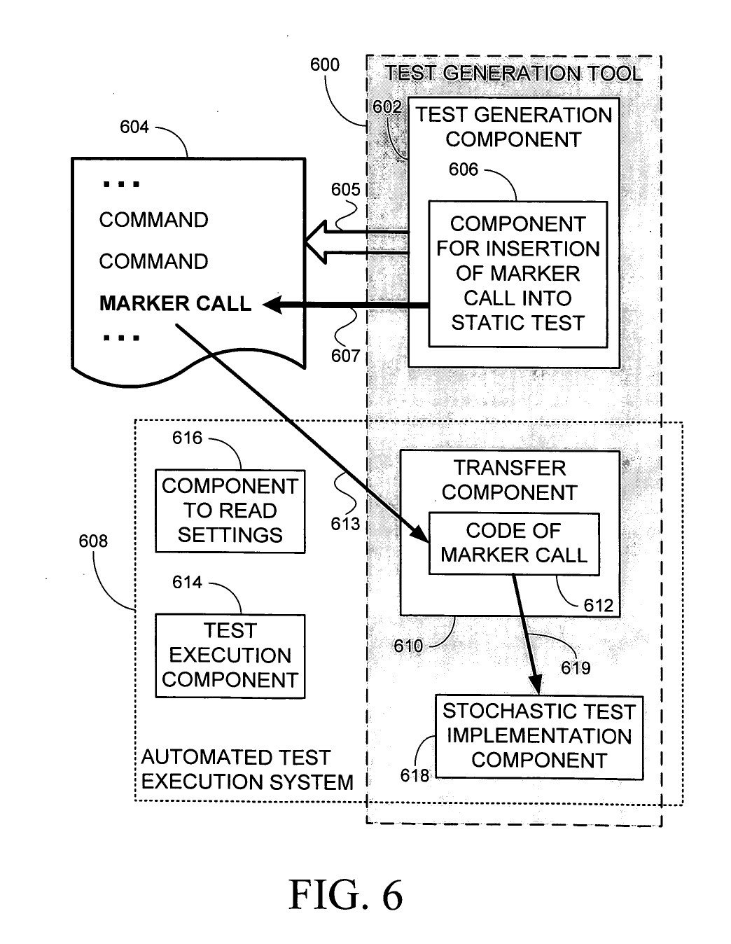

FIG. 6 is a block diagram of a test generation tool and an automated test execution system, according to some embodiments of the invention. A test generation tool 600 includes a test generation component 602 that is able to create a static test of software. An excerpt 604 of an example static test is illustrated in FIG. 6, and the creation of the static test is illustrated by an arrow 605. Test generation component 602 includes a component 606 for insertion of a marker call into the static test, the insertion illustrated by an arrow 607. Once the test is ready for execution, an automated test execution system 608 is used to execute the test.

A transfer component 610 enables a stochastic test to be optionally applied to the software during execution of the static test of the software. For example, transfer component 610 includes code 612 that implements the method of FIG. 3. Code 612 is called by the marker call in the static test, as illustrated by an arrow 613. A non-exhaustive list of examples for the format of code 612 includes interpretable code, uncompiled computer instructions, compiled computer-executable instructions, compiled objects, and the like.

Automated test execution system 608 includes a component 614 for automated execution of tests of software and a component 616 to read settings. For example, the settings may be set by the person planning the tests and stored in a file or database. Transfer component 610, when executed, uses one or more of the settings read by component 616 to determine whether the stochastic test is to be applied to the software during execution of the static test of the software and if so, in which state the software will be when the stochastic test is applied to the software. Code 612 includes a call to a component 618 that implements the stochastic test, as illustrated by arrow 619.

Component 618 may be included in test generation tool 600 and/or automated test execution system 608 depending on the precise implementation. Similarly, transfer component 610 may be included in test generation tool 600 and/or automated test execution system 608 depending on the precise implementation.

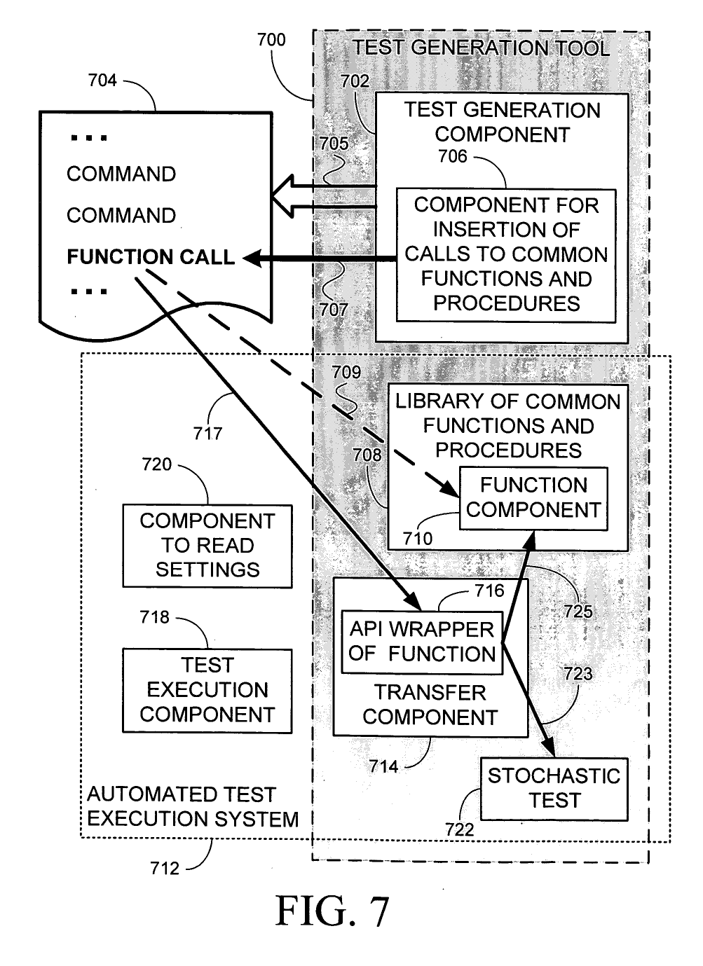

FIG. 7 is a block diagram of a test generation tool and an automated test execution system, according to other embodiments of the invention. A test generation tool 700 includes a test generation component 702 that is able to create a static test of software. An excerpt 704 of an example static test is illustrated in FIG. 7, and the creation of the static test is illustrated by an arrow 705. Test generation component 702 includes a component 706 for insertion into the static test of calls to common functions and procedures. The common functions and procedures are supplied in a library component 708. For example, library component 708 includes a component 710 of a particular function, an arrow 707 illustrates the insertion of a call to the particular function by component 706 into the static test, and a dashed arrow 709 illustrates the connection between the function call in the static test and component 710. Once the test is ready for execution, an automated test execution system 712 is used to execute the test.

A transfer component 714 intercepts any calls in the static test to the particular function, thus enabling a stochastic test to be optionally applied to the software during execution of the static test of the software. For example, transfer component 714 includes an API wrapper component 716 that implements the method of FIG. 5. API wrapper component 716 intercepts the call in the static test to the particular function, as illustrated by an arrow 717. A non-exhaustive list of examples for component 716 includes interpretable code, uncompiled computer instructions, compiled computer-executable instructions, compiled objects, and the like.

Automated test execution system 712 includes a component 718 for automated execution of tests of software and a component 720 to read settings. For example, the settings may be set by the person planning the tests and stored in a file or database. Transfer component 714, when executed, uses one or more of the settings read by component 720 to determine whether a stochastic test is to be applied to the software during execution of a static test of the software and if so, in which state the software will be when the stochastic test is applied to the software. API wrapper component 716 includes a call to a component 722 that implements the stochastic test, as illustrated by arrow 723 and includes a call to the actual particular function component 710, as illustrated by arrow 725.

Component 722 may be included in test generation tool 700 and/or automated test execution system 708, depending on the precise implementation. Similarly, each of library component 708 and transfer component 714 may be included in test generation tool 700 and/or automated test execution system 708, depending on the precise implementation.

The automated test execution system is not mandatory and some tests may be run as stand-alone executables.

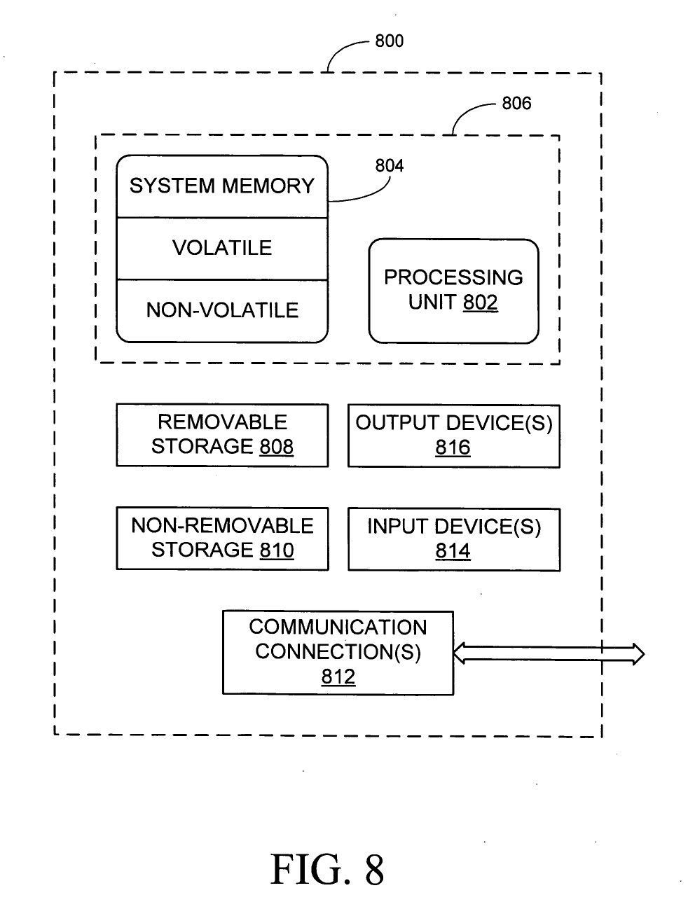

FIG. 8 illustrates an exemplary system for implementing embodiments of the invention, the system including one or more computing devices, such as computing device 800. In its most basic configuration, device 800 typically includes at least one processing unit 802 and memory 804. Depending on the exact configuration and type of computing device, memory 804 may be volatile (such as random access memory (RAM)), non-volatile (such as read-only memory (ROM), flash memory, etc.) or some combination of the two. This most basic configuration is illustrated in FIG. 8 by dashed line 806.

Additionally, device 800 may also have additional features or functionality. For example, device 800 may also include additional storage (removable and/or non-removable) including, but not limited to, magnetic or optical disks or tape. Such additional storage is illustrated in FIG. 8 by removable storage 808 and non-removable storage 810.

Computer storage media includes volatile and nonvolatile, removable and non-removable media implemented in any method or technology for storage of information such as computer readable instructions, data structures, program modules or other data. Memory 804, removable storage 808 and non-removable storage 810 are all examples of computer storage media. Computer storage media includes, but is not limited to, random access memory (RAM), read-only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other medium which can be used to store the desired information and which can be accessed by computing device 800. Any such computer storage media may be part of device 800.

Device 800 may also contain communication connection(s) 812 that allow the device to communicate with other devices. Communication connection(s) 812 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. The term computer readable media as used herein includes both storage media and communication media.

Device 800 may also have input device(s) 814 such as keyboard, mouse, pen, voice input device, touch input device, etc. Output device(s) 816 such as a display, speakers, printer, etc. may also be included. All these devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for automated testing of software, the method comprising:
implementing commands of a static automated test of said software to drive said software into a particular state;
suspending said static test; and
applying a stochastic test to said software in said particular state.

2. The method of claim 1, wherein suspending said static test comprises:
suspending said static test at a call to code that optionally transfers execution to said stochastic test and that otherwise returns directly to said static test.

3. The method of claim 1, wherein suspending said static test comprises:
suspending said static test at code that optionally transfers execution to said stochastic test and that otherwise continues said static test.

4. The method of claim 1, wherein suspending said static test comprises:
suspending said static test at a call to code that optionally transfers execution to said stochastic test and that otherwise calls another function or procedure.

5. The method of claim 1, wherein said stochastic test is a stateless stochastic test.

6. The method of claim 5, wherein said stochastic test is completely ignorant of said software.

7. One or more computer-readable media having computer-executable components comprising:
a component for automated execution of tests of software; and
a component to read settings, where one or more of said settings determine whether a stochastic test is to be applied to said software during execution of a static test of said software and if so, in which state said software will be when said stochastic test is applied to said software.

8. The computer-readable media of claim 7, further comprising:
a component to implement said stochastic test.

9. The computer-readable media of claim 8, wherein said stochastic test is a stateless stochastic test.

10. The computer-readable media of claim 9, wherein said stochastic test is completely ignorant of said software.

11. The computer-readable media of claim 7, further comprising:
a transfer component to optionally apply said stochastic test to said software according to said one or more of said settings.

12. The computer-readable media of claim 11, wherein said transfer component comprises a component to intercept one or more calls in said static test to a particular function or procedure.

13. The computer-readable media of claim 12, wherein said component to intercept said one or more calls comprises an application programming interface (API) wrapper of said particular function or procedure.

14. One or more computer-readable media having computer-executable components comprising:
a test generation component to enable design and creation of a static test of software; and
a transfer component to enable a stochastic test to be optionally applied to said software during execution of said static test.

15. The computer-readable media of claim 14, further comprising:
a component to implement said stochastic test.

16. The computer-readable media of claim 15, wherein said stochastic test is a stateless stochastic test.

17. The computer-readable media of claim 16, wherein said stochastic test is completely ignorant of said software.

18. The computer-readable media of claim 14, wherein said transfer component comprises code that optionally applies said stochastic test to said software, and said test generation component comprises a component that enables insertion into said static test of one or more calls to said code.

19. The computer-readable media of claim 14, wherein said test generation component comprises a component that enables insertion into said static test of one or more calls to a particular function or procedure, and said transfer component comprises a component to intercept said one or more calls to optionally apply said stochastic test to said software.

20. The computer-readable media of claim 19, wherein said component to intercept said one or more calls comprises an application programming interface (API) wrapper of said particular function or procedure.
